(19) United States
(12) Patent Application Publication
(10) Pub. No.: US 2023/0095267 A1
(43) Pub. Date: Mar. 30, 2023

(54) QUANTUM DATA AND STATE SYNCHRONIZATION

(71) Applicant: Red Hat, Inc., Raleigh, NC (US)

(72) Inventors: Stephen Coady, Waterford (IE); Leigh Griffin, Waterford (IE)

(21) Appl. No.: 17/487,790

(22) Filed: Sep. 28, 2021

(51) Int. Cl. G06N 10/00; G06F 16/178; G06F 15/16

(52) U.S. Cl. CPC G06N 10/00; G06F 16/178; G06F 15/16

(57) ABSTRACT

Performing quantum data and state synchronization is disclosed herein. In one example, a quantum computing device comprises a system memory and a processor device communicatively coupled to the system memory. The processor device is to detect a synchronization trigger event corresponding to a first qubit of a first quantum file. Responsive to detecting the synchronization trigger event, the processor device is to perform one or more synchronization operations on a destination synchronization file based on the synchronization trigger event. The destination synchronization file may comprise a second quantum file, or a classical file on a classical computing device. The synchronization trigger event may comprise a modification of a data value stored by the first qubit, a completion of execution of a quantum service, a notification of an upcoming qubit deallocation, a modification of a quantum state of the first qubit, or a teleportation of quantum information using the first qubit.

### BACKGROUND

Quantum computing involves the use of quantum bits, referred to herein as “qubits,” which have characteristics that differ from those of classical (i.e., non-quantum) bits used in classical computing. Qubits may be employed by quantum services that are executed by quantum computing devices. As quantum computing continues to increase in popularity and become more commonplace, an ability to synchronize data values and/or quantum states of qubits will be desirable.

### SUMMARY

The examples disclosed herein implement a synchronization service for performing quantum data and state synchronization. The synchronization service, executing on a quantum computing device, detects a synchronization trigger event corresponding to a qubit, and, in response, performs one or more synchronization operations on a destination file (e.g., a quantum file or a classical file) based on the synchronization trigger event. In this manner, a data value and/or a quantum state of the qubit may be automatically propagated to a qubit of another quantum computing device, and/or may be stored in a classical file of a classical computing device.

In one example, a method for performing quantum data and state synchronization is disclosed. The method comprises detecting, by a quantum computing device, a synchronization trigger event corresponding to a first qubit of a first quantum file. The method further comprises, responsive to detecting the synchronization trigger event, performing one or more synchronization operations on a destination synchronization file based on the synchronization trigger event.

In another example, a quantum computing device for performing quantum data and state synchronization is disclosed. The quantum computing device comprises a system memory and a processor device communicatively coupled to the system memory. The processor device is to detect a synchronization trigger event corresponding to a first qubit of a first quantum file. The processor device is further to, responsive to detecting the synchronization trigger event, perform one or more synchronization operations on a destination synchronization file based on the synchronization trigger event.

In another example, a non-transitory computer-readable medium is disclosed. The non-transitory computer-readable medium stores thereon computer-executable instructions that, when executed, cause one or more processor devices to detect a synchronization trigger event corresponding to a first qubit of a first quantum file. The computer-executable instructions further cause the one or more processor devices to, responsive to detecting the synchronization trigger event, perform one or more synchronization operations on a destination synchronization file based on the synchronization trigger event.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of a computing system in which examples may be practiced;

FIGS. 2A-2B are flowcharts illustrating operations performed by the computing system of FIG. 1 for performing quantum data and state synchronization, according to one example;

FIG. 3 is a simpler block diagram of the computing system of FIG. 1 for performing quantum data and state synchronization, according to one example;

FIG. 4 is a flowchart of a simplified method for performing quantum data and state synchronization by the staging computing device of FIG. 3, according to one example;

FIG. 5 is a block diagram of a quantum computing device suitable for implementing examples, according to one example; and

FIG. 6 is a block diagram of a classical computing device suitable for implementing examples, according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first qubit” and “second qubit,” and does not imply a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B.

Quantum computing involves the use of quantum bits, referred to herein as “qubits,” which have characteristics that differ from those of classical (i.e., non-quantum) bits used in classical computing. Qubits may be employed by quantum services that are executed by quantum computing devices. As quantum computing continues to increase in popularity and become more commonplace, an ability to synchronize data values and/or quantum states of qubits will be desirable. In particular, it may be desirable to provide functionality for automatically propagating data values and/or quantum states from qubits involved in quantum operations to qubits used by different services or quantum computing devices, or storing such data values and/or quantum states in classical files on a classical computing device, in response to different trigger events such as quantum service execution completion or impending qubit deallocation.

In this regard, the examples disclosed herein implement a synchronization service for performing quantum data and state synchronization. In exemplary operation, the synchronization service, executing on a quantum computing device, detects a synchronization trigger event that corresponds to a first qubit of a first quantum file. In response, the synchronization service performs one or more synchronization operations on a destination synchronization file based on the synchronization trigger event. The particular synchronization operation(s) that are performed may vary depending on a type of synchronization trigger event that is detected. For instance, in some examples, the synchronization trigger event may comprise a modification of a data value stored by the first qubit, a completion of execution of a quantum service that employs the first qubit, or a notification of an upcoming deallocation of the first qubit. In such examples, operations for performing the one or more synchronization operations may include writing the data value stored by the first qubit to the destination synchronization file. Some examples may provide that the synchronization trigger event may comprise a modification of a quantum state of the first qubit or a teleportation of quantum information using the first qubit. According to such examples, operations for performing the one or more synchronization operations may include writing the quantum state of the first qubit to the destination synchronization file.

In some examples, the destination synchronization file may comprise a second quantum file (on the same quantum computing device or on a different quantum computing device) that comprises a second qubit. Such examples may provide that operations for writing the data value stored by the first qubit or the quantum state of the first qubit to the destination synchronization file comprises writing the data value or the quantum state, respectively, to the second qubit. According to some examples, the destination synchronization file may comprise a classical file (e.g., stored on a classical computer that is communicatively coupled to the quantum computing device). In such examples, operations for writing the data value stored by the first qubit or the quantum state of the first qubit to the destination synchronization file comprises writing an indication of the data value or an indication of the quantum state, respectively, to the classical file in association with an identification of the first qubit.

The examples discussed above, in which a data value or a quantum state are written to the second qubit, may further include operations for ensuring safe access to the second qubit. The synchronization service in such examples may first determine that the second qubit is in an access-safe state (e.g., not in a state of entanglement or superposition that may be disrupted by modifying the data value or quantum state of the second qubit, as a non-limiting example). After determining that the second qubit is in an access-safe state, the synchronization service may then obtain write access to the second qubit. These operations may be performed, in some examples, by accessing functionality provided by a qubit registry of the quantum computing device.

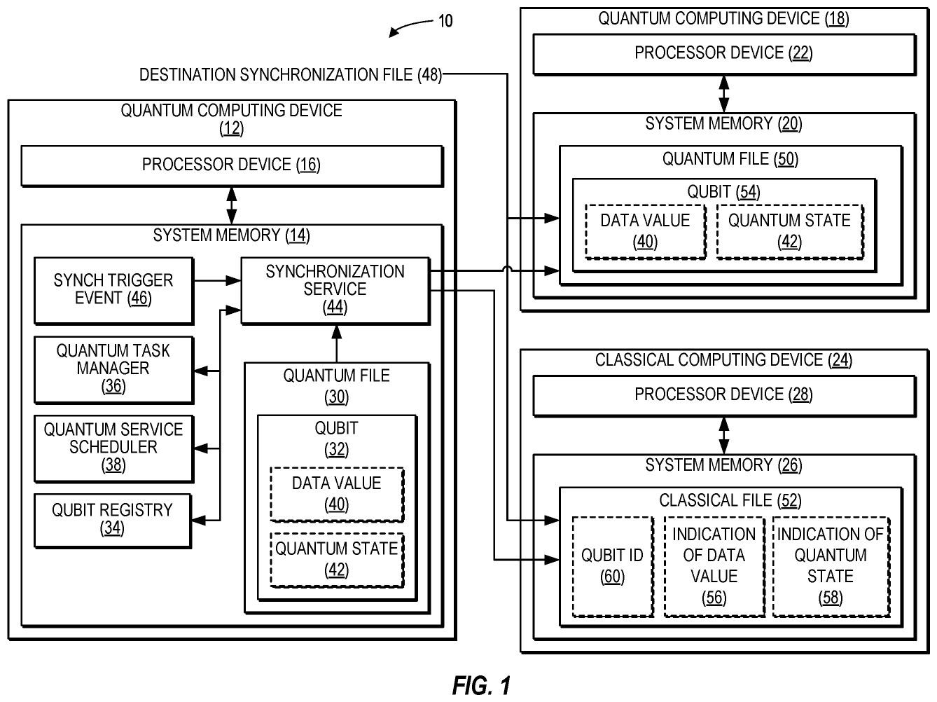

FIG. 1 is a block diagram of a computing system 10 according to one example. The computing system 10 includes a quantum computing device 12 that comprises a system memory 14 and a processor device 16, as well as a quantum computing device 18 that comprises a system memory 20 and a processor device 22. The computing system 10 of FIG. 1 also includes a classical computing device 24 that comprises a system memory 26 and a processor device 28. The quantum computing device 12, the quantum computing device 18, and the classical computing device 24 in the example of FIG. 1 are all communicatively coupled via a classical communications link (not shown), which may comprise a private network or a public network such as the internet. The quantum computing device 12 and the quantum computing device 18 may also be communicatively coupled via a quantum channel (not shown) over which qubits may be transmitted. It is to be understood that the computing system 10, according to some examples, may include more or fewer quantum computing devices and/or classical computing devices than illustrated in FIG. 1. Additionally, the quantum computing device 12, the quantum computing device 18, and/or the classical computing device 24 in some examples may include constituent elements in addition to those illustrated in FIG. 1.

The quantum computing device 12 and the quantum computing device 18 in the example of FIG. 1 operate in quantum environments, but are capable of operating using classical computing principles or quantum computing principles. When using quantum computing principles, the quantum computing device 12 and the quantum computing device 18 perform computations that utilize quantum-mechanical phenomena, such as superposition and/or entanglement states. The quantum computing device 12 and the quantum computing device 18 may operate under certain environmental conditions, such as at or near zero degrees (0°) Kelvin. When using classical computing principles, the quantum computing device 12 and the quantum computing device 18 utilize binary digits that have a value of either zero (0) or one (1).

In the example of FIG. 1, the quantum computing device 12 implements a set of one or more qubits that may be grouped into quantum files, such as a quantum file 30 comprising a qubit 32. To maintain information for qubits such as the qubit 32, the quantum computing device 12 may include a qubit registry 34, which comprises a plurality of qubit registry entries each corresponding to a qubit such as the qubit 32. The qubit registry 34 maintains and provides access to data relating to the qubits implemented by the quantum computing device 12, such as a count of the total number of qubits implemented by the quantum computing device 12 and a count of the number of available qubits that are currently available for allocation, as non-limiting examples. Each of the qubit registry entries of the qubit registry 34 also stores qubit metadata for a corresponding qubit. The qubit metadata may include, as non-limiting examples, an identifier of the corresponding qubit, an availability indicator that indicates whether the corresponding qubit is available for use or is in use by a specific quantum service, an identifier of a quantum service that is associated with the corresponding qubit or to which the corresponding qubit is allocated, and/or an entanglement indicator that indicates whether the corresponding qubit is in an entangled state.

The quantum computing device 12 of FIG. 1 may execute one or more quantum services (not shown), which may comprise processes that employ quantum files such as the quantum file 30 and/or qubits such as the qubit 32 to provide desired functionality. Execution of quantum services is facilitated by a quantum task manager 36 and a quantum service scheduler 38, which operate in a manner analogous to their conventional classical counterparts. Thus, the quantum task manager 36 of the quantum computing device 12 handles operations for creating, monitoring, and terminating quantum services, while the quantum service scheduler 38 of the quantum computing device 12 controls the scheduling of quantum services for execution by the processor device 16, and the allocation of processing resources to executing quantum services. The functionality of the quantum task manager 36 and the quantum service scheduler 38 may be made accessible to other services and processes (e.g., via a defined application programming interface (API), as a non-limiting example).

The qubit 32 of the quantum file 30 may be used to store a data value 40, and/or may have a quantum state 42 (e.g., spin, as a non-limiting example) into which the qubit 32 is programmatically placed. Circumstances may arise in which it is desirable to automatically propagate the data value 40 and/or the quantum state 42 of the qubit 32 to another qubit, or to otherwise store data regarding the data value 40 and/or the quantum state 42. For example, the data value 40 may have been modified as a result of execution of a quantum service, the quantum state 42 may have been modified as a result of teleportation involving the qubit 32, or the qubit 32 may be scheduled for deallocation by the qubit registry 34.

In this regard, the quantum computing device 12 of FIG. 1 implements a synchronization service 44 for performing quantum data and state synchronization. The synchronization service 44 in the example of FIG. 1 is communicatively coupled to the quantum task manager 36, the quantum service scheduler 38, and the qubit registry 34, and thus may access data related to qubit allocation and deallocation, qubit state, the use of qubits by executing quantum services, and the current and upcoming state of executing quantum services, as non-limiting examples. The synchronization service 44 may comprise a table or other appropriate data structure for associating qubits such as the qubit 32 with devices that have requested synchronization updates for the qubit 32, such as the quantum computing device 18 and/or the classical computing device 24. The synchronization service 44 may also receive from other services a synchronization request (not shown) that specifies a qubit such as the qubit 32 as a synchronization source, and that designates a destination synchronization file as a synchronization target.

In exemplary operation, the synchronization service 44 detects a synchronization trigger event (captioned as “SYNCH TRIGGER EVENT” in FIG. 1) 46 that corresponds to the qubit 32 of the quantum file 30 (e.g., based on data obtained or received from the quantum task manager 36, the quantum service scheduler 38, and/or the qubit registry 34, as non-limiting examples). Responsive to detecting the synchronization trigger event 46, the synchronization service 44 performs one or more synchronization operations on a destination synchronization file 48 based on the synchronization trigger event 46. As discussed in greater detail below, the destination synchronization file 48 may comprise a quantum file 50 of the quantum computing device 18, or may comprise a classical file 52 of the classical computing device 24.

The type of the synchronization trigger event 46 that is detected by the synchronization service 44 may determine the specific synchronization operation(s) that are performed on the destination synchronization file 48. Some examples may provide that the synchronization trigger event 46 comprises a modification of the data value 40 of the qubit 32, a completion of execution of a quantum service that employs the qubit 32, or a notification of an upcoming deallocation of the qubit 32 (e.g., from the qubit registry 34). In such examples, operations for performing the one or more synchronization operations may include writing the data value 40 stored by the qubit 32 to the destination synchronization file 48. According to some examples, the synchronization trigger event 46 may comprise a modification of the quantum state 42 of the qubit 32 or a teleportation of quantum information using the qubit 32. In such examples, operations for performing the one or more synchronization operations may include writing the quantum state 42 of the qubit 32 to the destination synchronization file 48.

As noted above, the destination synchronization file 48 in some examples may comprise another quantum file, such as the quantum file 50 that comprises a qubit 54. Such examples may provide that operations for writing the data value 40 stored by the qubit 32 or the quantum state 42 of the qubit 32 to the destination synchronization file 48 comprise writing the data value 40 or the quantum state 42, respectively, to the qubit 54. According to some examples, the destination synchronization file 48 may comprise a classical file 52 that is stored on the classical computing device 24. The classical file 52 may comprise, as non-limiting examples, a spreadsheet file, a text file, or any other suitable conventional data file. In such examples, operations for writing the data value 40 stored by the qubit 32 or the quantum state 42 of the qubit 32 to the destination synchronization file 48 comprise writing an indication 56 of the data value 40 or an indication 58 of the quantum state 42, respectively, to the classical file 52 in association with an identification (captioned as “QUBIT ID” in FIG. 1) 60 of the qubit 32 (e.g., an identifier assigned to the qubit 32 by the qubit registry 34). The indication 56 of the data value 40 may comprise, as non-limiting examples, a binary representation or a text representation of the data value 40, while the indication 58 of the quantum state 42 may comprise any suitable implementation-specific notation or encoding of the quantum state 42.

In examples such as those in which the data value 40 and/or the quantum state 42 are written to the qubit 54, the synchronization service 44 may further perform operations for ensuring safe access to the qubit 54. The synchronization service 44 in such examples may first determine that the qubit 54 is in an access-safe state (e.g., not in a state of entanglement or superposition that may be disrupted by modifying a data value or quantum state of the qubit 54, as a non-limiting example). After determining that the qubit 54 is in an access-safe state, the synchronization service 44 may then obtain write access to the qubit 54. These operations may be performed in some examples by accessing functionality provided by a qubit registry (not shown) of the quantum computing device 18.

It is to be understood that, because the synchronization service 44 is a component of the quantum computing device 12, functionality implemented by the synchronization service 44 may be attributed to the computing system 10 generally. Moreover, in examples where the synchronization service 44 comprises software instructions that program the processor device 16 to carry out functionality discussed herein, functionality implemented by the synchronization service 44 may be attributed herein to the processor device 16. It is to be further understood that while, for purposes of illustration only, the synchronization service 44 is depicted as a single component, the functionality implemented by the synchronization service 44 may be implemented in any number of components, and the examples discussed herein are not limited to any particular number of components. Moreover, it is noted that while, for purposes of illustration and simplicity, the examples are illustrated as being implemented by a processor device set that includes a single processor device on a single computing device, in other environments, such as a distributed and/or clustered environment, the examples may be implemented on a computer system that includes a processor device set that includes a plurality of processor devices of a plurality of different computing devices, and functionality of the examples may be implemented on different processor devices of different computing devices. Thus, irrespective of the implementation, the examples may be implemented on a computer system that includes a processor device set made up of one or more processor devices of one or more computing devices.

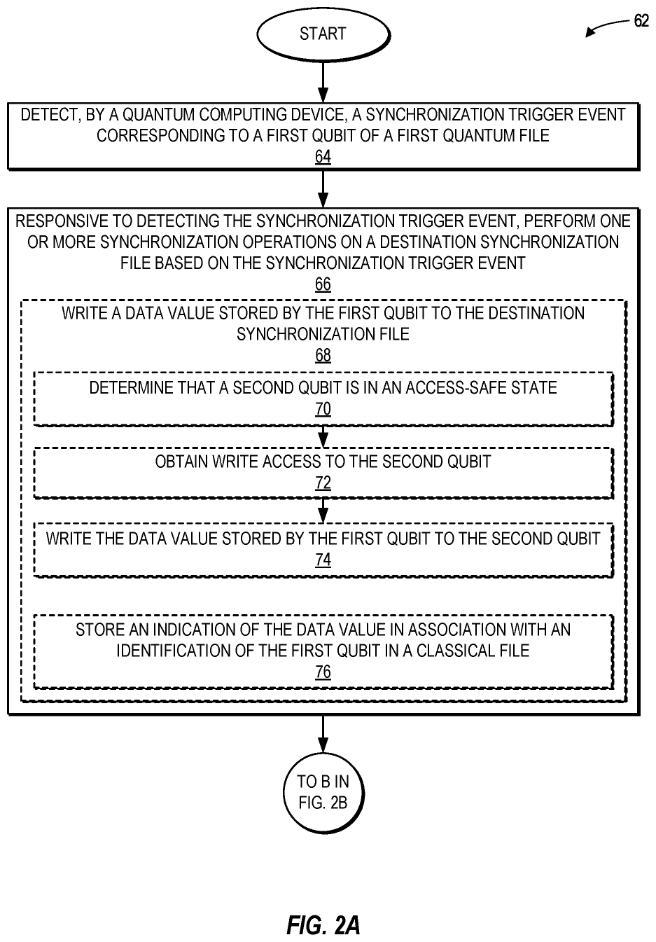

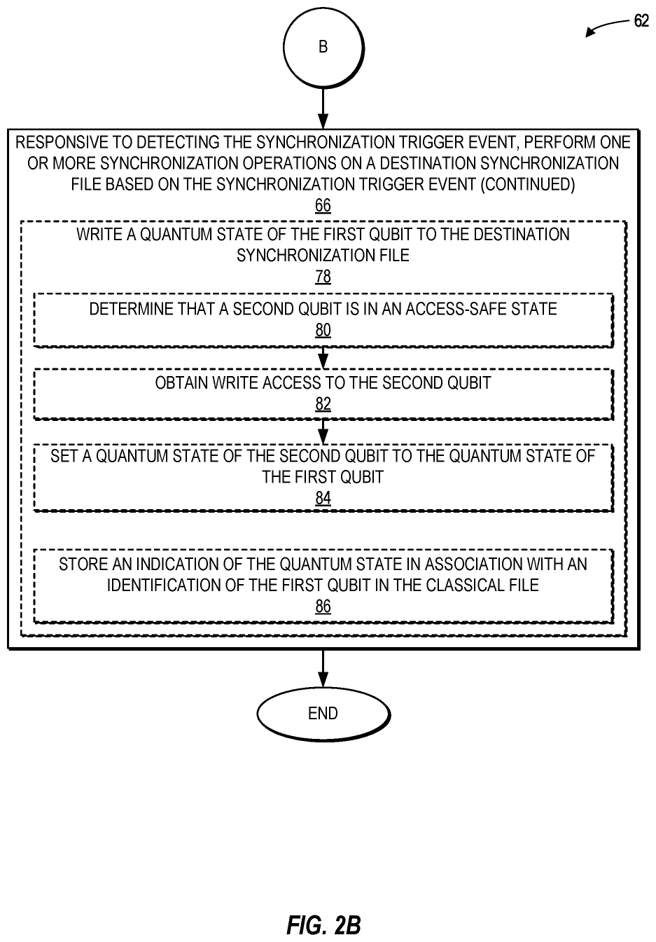

To illustrate exemplary operations performed by the computing system 10 of FIG. 1 for performing quantum data and state synchronization according to one example, FIGS. 2A and 2B provide a flowchart 62. Elements of FIG. 1 are referenced in describing FIGS. 2A and 2B for the sake of clarity. In FIG. 2A, operations begin with the processor device 16 of the quantum computing device 12 (e.g., by executing the synchronization service 44 of FIG. 1) detecting a synchronization trigger event (such as the synchronization trigger event 46 of FIG. 1) corresponding to a first qubit (e.g., the qubit 32 of FIG. 1) of a first quantum file (e.g., the quantum file 30 of FIG. 1) (block 64). Responsive to detecting the synchronization trigger event 46, the processor device 16 performs one or more synchronization operations on a destination synchronization file (e.g., the destination synchronization file 48 of FIG. 1) based on the synchronization trigger event 46 (block 66).

In some examples, the operations of block 66 for performing the one or more synchronization operations on the destination synchronization file 48 may comprise writing the data value 40 stored by the first qubit 32 to the destination synchronization file 48 (block 68). In examples in which the destination synchronization file 48 is the quantum file 50 of FIG. 1, the operations of block 68 for writing the data value 40 to the destination synchronization file 48 may comprise first determining that the second qubit 54 is in an access-safe state (block 70). The processor device 16 next may obtain write access to the second qubit 54 (block 72). The processor device 16 may then write the data value 40 stored by the first qubit 32 to the second qubit 54 (block 74). In examples in which the destination synchronization file 48 is the classical file 52 of FIG. 1, the operations of block 68 for writing the data value 40 to the destination synchronization file 48 may comprise storing an indication of the data value 40 (e.g., the indication 56 of FIG. 1) in association with an identification of the first qubit 32 (e.g., the identification 60 of FIG. 1) in the classical file 52 (block 76). Operations in some examples may continue at block 78 of FIG. 2B.

Referring now to FIG. 2B, some examples may provide that the operations of block 66 of FIG. 2A for performing the one or more synchronization operations on the destination synchronization file 48 may comprise writing the quantum state 42 of the first qubit 32 to the destination synchronization file 48 (block 78). According to examples in which the destination synchronization file 48 is the quantum file 50 of FIG. 1, the operations of block 78 for writing the quantum state 42 to the destination synchronization file 48 may comprise first determining that the second qubit 54 is in an access-safe state (block 80). The processor device 16 next may obtain write access to the second qubit 54 (block 82). The processor device 16 may then set the quantum state 42 of the second qubit 54 to the quantum state 42 of the first qubit 32 (block 84). For examples in which the destination synchronization file 48 is the classical file 52 of FIG. 1, the operations of block 78 for writing the quantum state 42 of the first qubit 32 to the destination synchronization file 48 may comprise storing an indication of the quantum state 42 (e.g., the indication 58 of FIG. 1) in association with the identification 60 of the first qubit 32 in the classical file 52 (block 86).

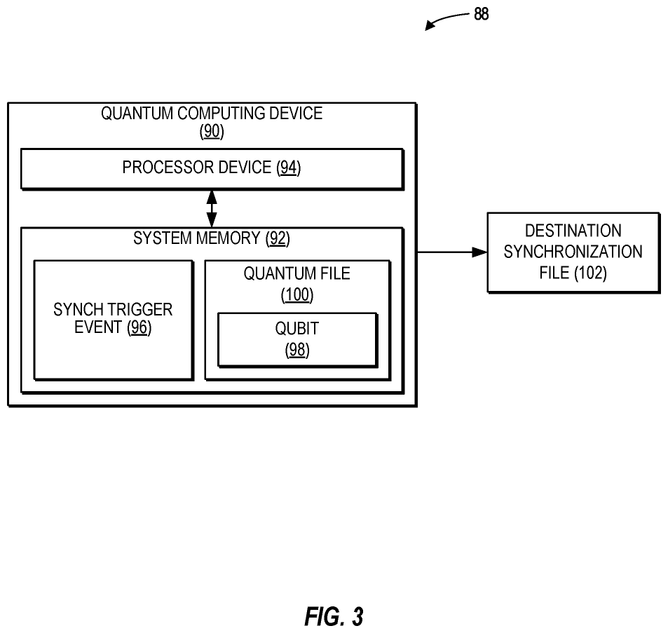

FIG. 3 is a simpler block diagram of the computing system 10 of FIG. 1 for performing quantum data and state synchronization, according to one example. In the example of FIG. 3, a computing system 88 includes a quantum computing device 90 that comprises a system memory 92 and a processor device 94. In exemplary operation, the processor device 94 detects a synchronization trigger event (captioned as “SYNCH TRIGGER EVENT” in FIG. 3) 96 that corresponds to a qubit 98 of a quantum file 100. Responsive to detecting the synchronization trigger event 96, the processor device 94 performs one or more synchronization operations on a destination synchronization file 102 based on the synchronization trigger event 96.

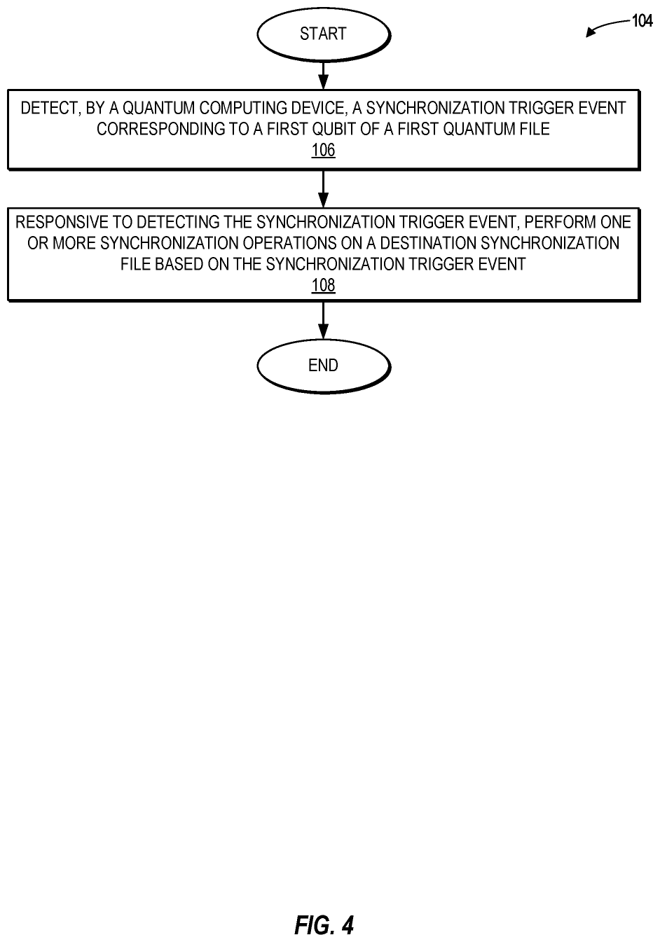

FIG. 4 provides a flowchart 104 of a simplified method for performing quantum data and state synchronization by the quantum computing device 90 of FIG. 3, according to one example. For the sake of clarity, elements of FIG. 3 are referenced in describing FIG. 4. Operations in FIG. 4 begin with the processor device 94 detecting a synchronization trigger event 96 corresponding to a first qubit 98 of a first quantum file 100 (block 106). Responsive to detecting the synchronization trigger event 96, the processor device 94 performs one or more synchronization operations on a destination synchronization file 102 based on the synchronization trigger event 96 (block 108).

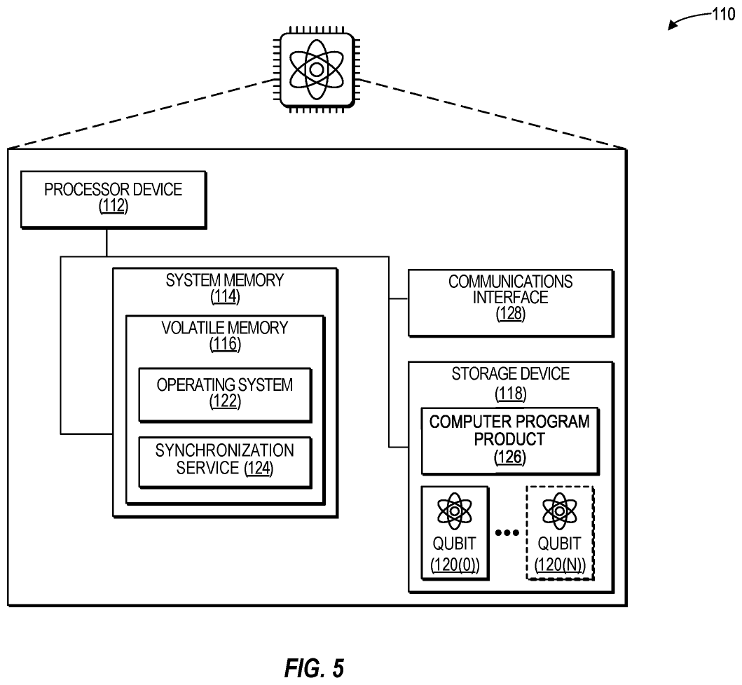

FIG. 5 is a block diagram of a quantum computing device 110, such as the quantum computing device 12 of FIG. 1, suitable for implementing examples according to one example. The quantum computing device 110 may comprise any suitable quantum computing device or devices. The quantum computing device 110 can operate using classical computing principles or quantum computing principles. When using quantum computing principles, the quantum computing device 110 performs computations that utilize quantum-mechanical phenomena, such as superposition and entanglement. The quantum computing device 110 may operate under certain environmental conditions, such as at or near zero degrees (0°) Kelvin. When using classical computing principles, the quantum computing device 110 utilizes binary digits that have a value of either zero (0) or one (1).

The quantum computing device 110 includes a processor device 112 and a system memory 114. The processor device 112 can be any commercially available or proprietary processor suitable for operating in a quantum environment. The system memory 114 may include volatile memory 116 (e.g., random-access memory (RAM)). The quantum computing device 110 may further include or be coupled to a non-transitory computer-readable medium such as a storage device 118. The storage device 118 and other drives associated with computer-readable media and computer-usable media may provide non-volatile storage of data, data structures, computer-executable instructions, and the like. The storage device may also provide functionality for storing one or more qubits 120(0)-120(N).

A number of modules can be stored in the storage device 118 and in the volatile memory 116, including an operating system 122 and one or more modules, such as a synchronization service 124. All or a portion of the examples may be implemented as a computer program product 126 stored on a transitory or non-transitory computer-usable or computer-readable medium, such as the storage device 118, which includes complex programming instructions, such as complex computer-readable program code, to cause the processor device 112 to carry out the steps described herein. Thus, the computer-readable program code can comprise computer-executable instructions for implementing the functionality of the examples described herein when executed on the processor device 112.

An operator may also be able to enter one or more configuration commands through a keyboard (not illustrated), a pointing device such as a mouse (not illustrated), or a touch-sensitive surface such as a display device (not illustrated). The quantum computing device 110 may also include a communications interface 128 suitable for communicating with other quantum computing systems, including, in some implementations, classical computing devices.

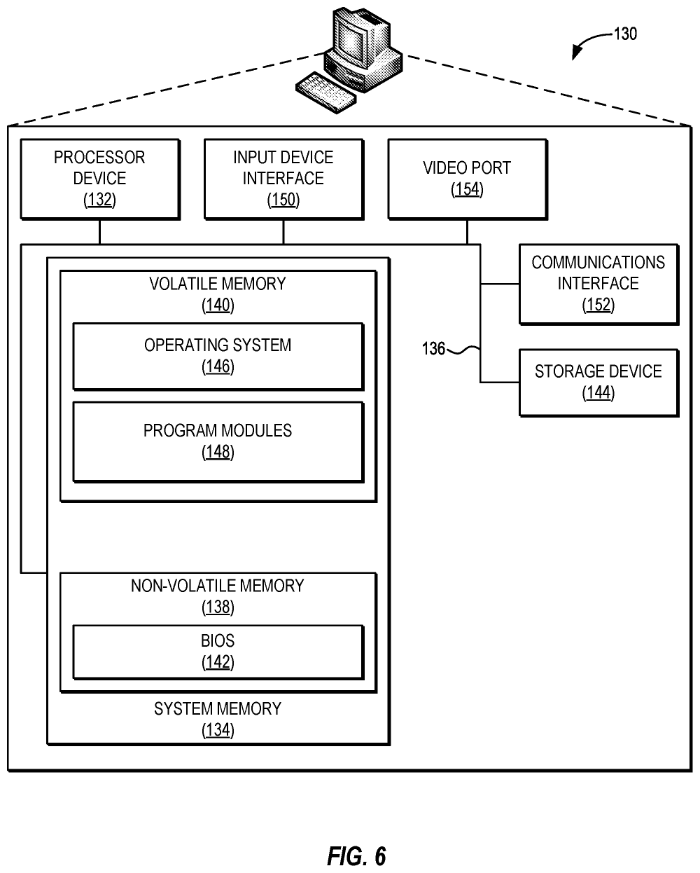

FIG. 6 is a block diagram of a processor-based computing device 130 (“computing device 130” or “classical computing device 130”), such as the classical computing device 24 of FIG. 1, suitable for implementing examples according to one example. The computing device 130 may comprise any computing or electronic device capable of including firmware, hardware, and/or executing software instructions to implement the functionality described herein, such as a computer server, a desktop computing device, a laptop computing device, a smartphone, a computing tablet, or the like. The computing device 130 includes a processor device 132, a system memory 134, and a system bus 136. The system bus 136 provides an interface for system components including, but not limited to, the system memory 134 and the processor device 132. The processor device 132 can be any commercially available or proprietary processor.

The system bus 136 may be any of several types of bus structures that may further interconnect to a memory bus (with or without a memory controller), a peripheral bus, and/or a local bus using any of a variety of commercially available bus architectures. The system memory 134 may include non-volatile memory 138 (e.g., read-only memory (ROM), erasable programmable ROM (EPROM), electrically EPROM (EEPROM), etc.), and volatile memory 140 (e.g., RAM). A basic input/output system (BIOS) 142 may be stored in the non-volatile memory 138 and can include the basic routines that help to transfer information among elements within the computing device 130. The volatile memory 140 may also include a high-speed RAM, such as static RAM, for caching data.

The computing device 130 may further include or be coupled to a non-transitory computer-readable storage medium such as a storage device 144, which may comprise, for example, an internal or external hard disk drive (HDD) (e.g., enhanced integrated drive electronics (EIDE) or serial advanced technology attachment (SATA)), for storage, flash memory, or the like. The storage device 144 and other drives associated with computer-readable media and computer-usable media may provide non-volatile storage of data, data structures, computer-executable instructions, and the like. Although the description of computer-readable media above refers to an HDD, it should be appreciated that other types of media that are readable by a computer, such as Zip disks, magnetic cassettes, flash memory cards, cartridges, and the like, may also be used in the operating environment, and, further, that any such media may contain computer-executable instructions for performing novel methods of the disclosed examples.

A number of modules can be stored in the storage device 144 and in the volatile memory 140, including an operating system 146 and one or more program modules 148 which may implement the functionality described herein in whole or in part. It is to be appreciated that the examples can be implemented with various commercially available operating systems 146 or combinations of operating systems 146. All or a portion of the examples may be implemented as a computer program product stored on a transitory or non-transitory computer-usable or computer-readable storage medium, such as the storage device 144, which includes complex programming instructions, such as complex computer-readable program code, to cause the processor device 132 to carry out the steps described herein. Thus, the computer-readable program code can comprise software instructions for implementing the functionality of the examples described herein when executed on the processor device 132. The processor device 132 may serve as a controller, or control system, for the computing device 130 that is to implement the functionality described herein.

An operator may also be able to enter one or more configuration commands through a keyboard (not illustrated), a pointing device such as a mouse (not illustrated), or a touch-sensitive surface such as a display device (not illustrated). Such input devices may be connected to the processor device 132 through an input device interface 150 that is coupled to the system bus 136 but can be connected by other interfaces, such as a parallel port, an Institute of Electrical and Electronic Engineers (IEEE) 1394 serial port, a Universal Serial Bus (USB) port, an IR interface, and the like.

The computing device 130 may also include a communications interface 152 suitable for communicating with a network as appropriate or desired. The computing device 130 may also include a video port 154 to interface with a display device to provide information to a user.

Individuals will recognize improvements and modifications to the preferred examples of the disclosure. All such improvements and modifications are considered within the scope of the concepts disclosed herein and the claims that follow.

What is claimed is:

1. A method, comprising:
detecting, by a quantum computing device, a synchronization trigger event corresponding to a first qubit of a first quantum file;
responsive to detecting the synchronization trigger event, performing one or more synchronization operations on a destination synchronization file based on the synchronization trigger event.

2. The method of claim 1, wherein:
the synchronization trigger event comprises one of a modification of a data value stored by the first qubit, a completion of execution of a quantum service employing the first qubit, and a notification of an upcoming deallocation of the first qubit; and
performing the one or more synchronization operations comprises writing the data value stored by the first qubit to the destination synchronization file.

3. The method of claim 2, wherein:
the destination synchronization file comprises a second quantum file comprising a second qubit; and
writing the data value stored by the first qubit to the destination synchronization file comprises writing the data value stored by the first qubit to the second qubit.

4. The method of claim 3, further comprising, prior to writing the data value stored by the first qubit to the second qubit:
determining that the second qubit is in an access-safe state; and
obtaining write access to the second qubit.

5. The method of claim 2, wherein:
the destination synchronization file is a classical file stored on a classical computing device that is communicatively coupled to the quantum computing device; and
writing the data value stored by the first qubit to the destination synchronization file comprises storing an indication of the data value in association with an identification of the first qubit in the classical file.

6. The method of claim 1, wherein:
the synchronization trigger event comprises one of a modification of a quantum state of the first qubit and a teleportation of quantum information using the first qubit; and
performing the one or more synchronization operations comprises writing the quantum state of the first qubit to the destination synchronization file.

7. The method of claim 6, wherein:
the destination synchronization file comprises a second quantum file comprising a second qubit; and
writing the quantum state of the first qubit to the destination synchronization file comprises setting a quantum state of the second qubit to the quantum state of the first qubit.

8. The method of claim 7, further comprising, prior to setting the quantum state of the second qubit to the quantum state of the first qubit:
determining that the second qubit is in an access-safe state; and
obtaining write access to the second qubit.

9. The method of claim 6, wherein:
the destination synchronization file is a classical file stored on a classical computing device that is communicatively coupled to the quantum computing device; and
writing the quantum state of the first qubit to the destination synchronization file comprises storing an indication of the quantum state in association with an identification of the first qubit in the classical file.

10. A quantum computing device, comprising:
a system memory; and
a processor device communicatively coupled to the system memory, the processor device to:
detect a synchronization trigger event corresponding to a first qubit of a first quantum file;
responsive to detecting the synchronization trigger event, perform one or more synchronization operations on a destination synchronization file based on the synchronization trigger event.

11. The quantum computing device of claim 10, wherein:
the synchronization trigger event comprises one of a modification of a data value stored by the first qubit, a completion of execution of a quantum service employing the first qubit, and a notification of an upcoming deallocation of the first qubit; and
to perform the one or more synchronization operations is to write the data value stored by the first qubit to the destination synchronization file.

12. The quantum computing device of claim 11, wherein:
the destination synchronization file comprises a second quantum file comprising a second qubit; and
to write the data value stored by the first qubit to the destination synchronization file is to write the data value stored by the first qubit to the second qubit.

13. The quantum computing device of claim 12, wherein the processor device is further to, prior to writing the data value stored by the first qubit to the second qubit:
determine that the second qubit is in an access-safe state; and
obtain write access to the second qubit.

14. The quantum computing device of claim 11, wherein:
the destination synchronization file is a classical file stored on a classical computing device that is communicatively coupled to the quantum computing device; and
to write the data value stored by the first qubit to the destination synchronization file is to store an indication of the data value in association with an identification of the first qubit in the classical file.

15. The quantum computing device of claim 10, wherein:
the synchronization trigger event comprises one of a modification of a quantum state of the first qubit and a teleportation of quantum information using the first qubit; and
to perform the one or more synchronization operations is to write the quantum state of the first qubit to the destination synchronization file.

16. The quantum computing device of claim 15, wherein:
the destination synchronization file comprises a second quantum file comprising a second qubit; and
to write the quantum state of the first qubit to the destination synchronization file is to set a quantum state of the second qubit to the quantum state of the first qubit.

17. The quantum computing device of claim 16, wherein the processor device is further to, prior to setting the quantum state of the second qubit to the quantum state of the first qubit:
determine that the second qubit is in an access-safe state; and
obtain write access to the second qubit.

18. The quantum computing device of claim 15, wherein:
the destination synchronization file is a classical file stored on a classical computing device that is communicatively coupled to the quantum computing device; and
to write the quantum state of the first qubit to the destination synchronization file is to store an indication of the quantum state in association with an identification of the first qubit in the classical file.

19. A non-transitory computer-readable medium having stored thereon computer-executable instructions that, when executed, cause one or more processor devices to:
detect a synchronization trigger event corresponding to a first qubit of a first quantum file;
responsive to detecting the synchronization trigger event, perform one or more synchronization operations on a destination synchronization file based on the synchronization trigger event.

20. The non-transitory computer-readable medium of claim 19, wherein the synchronization trigger event comprises one of a modification of a data value stored by the first qubit, a completion of execution of a quantum service employing the first qubit, a notification of an upcoming deallocation of the first qubit, a modification of a quantum state of the first qubit, and a teleportation of quantum information using the first qubit.
